(19) United States
(12) Patent Application Publication
(10) Pub. No.: US 2002/0018654 A1
(43) Pub. Date: Feb. 14, 2002

(54) Photo finishing system with ink-jet printer

(76) Inventors: Guido Keller, Adlikon (CH); Rainer Flohr, Regensdorf/ZH (CH)

Correspondence Address: PENNIE AND EDMONDS, 1155 AVENUE OF THE AMERICAS, NEW YORK, NY, 100362711

(21) Appl. No.: 09/916,751

(22) Filed: Jul. 27, 2001

(30) Foreign Application Priority Data
Aug. 2, 2000 (EP) 00 116 185.0

(51) Int. Cl. G03D 3/00

(52) U.S. Cl. 396/564

(57) ABSTRACT

The present invention relates to a photo finishing system for printing images on a sheet material comprising: an image data source for providing image data; and an ink-jet printer for printing an image on the sheet material in accordance with the image data.

### FIELD OF THE INVENTION

The present invention relates to a photo finishing system using at least one ink-jet printer, and more particularly to a photo finishing system for making a hard copy such as a photo print of an image obtained from a data source like e.g. an electronic memory, a data net work, or an exposed photographic film.

### BACKGROUND OF THE INVENTION

A conventional photo finishing system, such as a photographic mini-lab, is described in U.S. Pat. No. 5,432,580 and is explained with reference to FIGS. 6 and 7.

FIG. 6 shows a known photo finishing system and is constructed of a film processor 2 and a printer processor 3.

The film processor 2 has a film setting unit 4, various processing vessels 6 to 11, a drying unit 12, an image pickup unit 13, and a film stacker unit 14. An exposed photographic film, e.g. a color negative film 17, is wound up and accommodated within a cassette 18. In developing the color negative film 17, first the leader of the color negative film 17 is pulled out of the cassette 18 by using a known leader catching jig and the leader is joined with a leader sheet 19. The leader sheet 19 has perforations formed at the center thereof at an equal pitch. These perforations engage with an endless belt or sprocket having a number of protrusions also formed at the same pitch. Through this engagement, the film 17 is transported into the film processor 2.

The film setting unit 4 is loaded with the cassette 18 having the leader of the color negative film 17 joined to the leader sheet 19. As the leader sheet 19 advances, the color negative film 17 is pulled out of the cassette 18 and guided through the various processing vessels 6 to 11. When the color negative film 17 is completely pulled out of the cassette 18, the film trailing end is cut by a cutter 22 to separate the color negative film 17 from the cassette 18. As is well known, the processing vessels 6 to 11 include a color development vessel 6, a bleach vessel 7, a bleach-fix vessel 8, super rinsing vessels 9 and 10, and a stabilizing vessel 11. The negative film 17, after being processed in the processing vessels 6 to 11, is dried with hot air in the drying unit 12. The leader sheet 19 of the color negative film 17 exiting from the drying unit 12 is held by a hook 14a of the film stacker unit 14, after signals representing images of original frames of the film 17 have been generated by the image pickup unit 13 in the manner described below.

The color negative film 17 enters the image pickup unit 13 immediately past the drying process and passes between two transparent glass plates 23 and 24 and the images of original frames are read. In order to read the images of original frames, a light source unit 27, made of a lamp 25 and condensor lens unit 26, is mounted above the transparent glass plate 23. A cooling fan 28 is provided to circulate air around the lamp 25. Mounted under the transparent glass plate 24 are a slit plate 30, a lens 31, and a CCD line sensor 32. A narrow slit is formed in the slit plate 30 in the widthwise direction of the color negative film 17. Light passed through the color negative film 17 under transportation falls incident on the light-receiving surface of the color line sensor 32 via the slit plate 30 and lens 31.

The color line sensor 32 is constructed of a number of CCD elements disposed in a matrix and R, G, and B color mosaic filters mounted on each CCD line. Instead of a color image line sensor for reading an image, line-by-line, synchronously with the film advance, a color image area sensor may be used for reading an entire image of a film at one time. An image read circuit 33 drives the color line sensor 32 to read the image data corresponding to one line of the image on the film. This image data is sent to the printer-processor 3.

In the printer-processor 3, an image processing unit 34 processes the image data sent from the film processor 2. At the image processing unit 34, the color and density are corrected in a known manner. The image data with the corrected color and density is sent to a video printer unit 35 for printing and exposing a color photographic paper 36 developed by a paper processor unit 37 and cut by a cutter 38 and ejected onto tray 39.

FIG. 7 shows a printer-processor of the prior art for performing color negative film printing and video printing.

This printer-processor has a first exposure system 70 using the developed color negative film 17, and a second exposure system 76, whereby three color image data supplied from the film processor is displayed on a monochrome CRT 71 to perform three color frame sequential exposure while respectively inserting three color filters 72 to 74 into a print optical path 75. The first exposure system 70 is mainly used for extra printing of additional photoprints from previously processed film, and the second exposure system 76 is used for developing a new exposed photographic film and making photoprints.

In the first exposure system 70, the light source unit 80 applies light to a frame of the color negative film 17 to be printed, and focuses the light via a print lens 81 onto a color photographic paper 82, to thereby print the image frame onto the paper 82. The light source unit 80 has a light source 83, three color filters 84 to 86 for controlling the light intensity and balance of the light source 83 corresponding to each color, a color filter driving unit 88 for inserting the three color filters 84 to 86 into a print optical path 87, and a mixing box 89 for uniformly diffusing a printing light having controlled intensity and color balance. The color negative film 17 is set on a film carrier 90 which, as well known, sets the frame to be printed at a printing position.

The second exposure system 76 has the monochrome CRT 71, a printing lens 95 for focusing an image displayed on CRT 71 onto a color photographic paper 82, and a filter setting unit 96 for the three color frame sequential exposure of the image displayed on CRT 71 onto the color paper 82. A mirror 97 is mounted so as to be movable into and out of the print optical path 87 to focus an image to the color paper 82, by selecting one of the first and second exposure systems 70 and 76. A selecting unit 98 operates to set the mirror 97 either to a retracted position from the print optical path 87 or to a position where the mirror 97 is inserted into the print optical path 87 at an inclined angle of 45 degrees. Instead of the mirror 97 and selecting unit 98, a half mirror or half prism may be used to direct light in a known manner. TV camera 100 is used to display the image and the color negative film 17 on a monitor CRT 101. Reference numeral 102 represents a shutter driver for opening and closing a shutter 103.

A printed color paper 82 is transported to a paper processor unit 105 having a paper reservoir 106 for reserving a loop of the color paper 82 so as to absorb a difference between the printing speed and paper developing speed. The reserved color paper 82 of a predetermined length is thereafter developed at processing vessels 107 to 111, dried by a dryer drum 113, cut into each frame by a cutter 114, and ejected onto a print tray 115.

### SUMMARY OF THE INVENTION

It is an object of the present invention to provide a photo finishing system, a printer and a method, which allow to simplify and improve the printing of images.

According to one aspect of the invention, a photo finishing system can be embodied in a compact apparatus, like a mini-lab, and comprises an image data source for providing image data, which can be a film processor including one or more features of the film processor described above which can have a developing unit and a drying unit to execute a developing process and a drying process of an exposed photographic film. The apparatus can be arranged so as to perform simultaneously the developing and drying process to process exposed photographic films in a continuous manner. The processed photographic film is then transformed by an image scanner, which can be a line scanner or a scanner using arrays of picture sensing elements, such as CCD devices, into image signals which can have any physical representation, like being electrical signals, optical signals in an optical fibre and so on. The thus generated electrical image signal representing the image data of the processed photographic film is then transferred to at least one ink-jet printer for printing the image on a sheet material to obtain a hard copy or photoprint of the image of the exposed photographic film. The image data source can also be a data source providing directly digital data, e.g. a memory device like a memory stick or the memory of a digital camera, or a data network, like the Internet, so that a user can transmit image data. The use of an ink-jet printer for printing images as hard copies is advantageous compared to the above described technology using color filters and CRT devices, since an ink-jet printer is more compact and allows therefore the construction of a smaller and more compact photo finishing system compared to the known prior art photo finishing systems. Additionally, ink-jet printers are advantageous regarding maintenance and reliability, since less mechanical complicated devices are used in ink-jet printers compared to the above-described technology being based on various different elements, like a mirror, color filters and CRT devices. This leads to an ecological advantage, since the production of the inventive system consumes less resources. Furthermore, the operation of ink-jet printers is also ecologically advantageous compared to the prior art technology, since less chemicals are used. There is for example no need for a specific fluid in processing vessels, as required by the prior art technology.

In a preferred embodiment a multiplicity of ink-jet printers for printing images on sheet material in accordance with the image data are provided. It is advantageous to arrange each of the multiplicity of ink-jet printers in a module having input and output devices for the sheet material so that two or more modules each comprising at least one ink-jet printer can be put together or stacked in a simple manner so that sheet material can be distributed to the respective modules and can be sorted, preferably by a sheet distributing means arranged in the modules, after the printing process is finished. The sheet input and sheet output devices for distributing the sheet material are preferably arranged at basically the same place in each module so that in a defined arrangement of these modules, like stacking the modules, the sheet input and sheet output devices can interact with sheet input and sheet output devices of an adjacent module. Although it is advantageous to arrange the sheet input and sheet output devices in basically the same place in each module, ink-jet printers of a different type can be arranged in different modules to print pictures in different desired formats or different qualities as, for example, low resolution pictures or high resolution pictures.

In a preferred embodiment the sheet distributing means as, for example, sheet input or sheet output devices, are switching elements, which can receive a sheet material at an input of the switching element or can transport the sheet material to one of at least two outputs of the switching element, depending on control signals applied to the switching element. In general, the input or output devices can be switched electronically or by a software. For example, a multiplicity of modules each comprising at least one ink-jet printer and at least one input switching elements are stacked, and input sheet material is forwarded to the input of the input switching element of a first module and then transported either to a first output of the switching element, which is connected to the printer of the module or transported to a second output of the switching element to be entered into the input of a switching element of an adjacent module, depending on control signals based on customer requirements regarding the image to be printed. In such a manner, a sheet material can be transported to a specific printer in a stack of modules. Using the same mechanism for the output of the respective printers in each module, an output switching element can be provided in each module to transport the printed image to a tray located at the module or to trays located at other modules, or to an output sorter to sort the printed images according to user requirements.

In an embodiment several devices for feeding sheet material, like roll feed devices or devices for feeding sheets already cut into different formats are provided. Thus, e.g. each printer might have one or more separate sheet feeding devices to enable the printing of several formats and the use of several paper qualities, e.g. for greeting cards.

Generally the sheet feeding devices or the sheet input devices are operated according to the distribution of print tasks by a printer control device or a printer control software. The output of the respective printers is switched to sort the printed images or to convey the images to a separate sorter.

In a preferred embodiment the printers in the different modules are controlled by signals transmitted via a bus system. Interfaces can be provided at the respective modules to communicate via the bus system and a central controller can be provided to control the switching elements at the input and/or the output and/or the at least one ink-jet printer of each module to control a printing process such that preferably a continuous printing process using a single or more ink-jet printers can be performed.

It is advantageous that the ink supplied to the respective ink-jet printers in each module is provided at the respective modules via an ink supply line being connected to one or more central reservoirs, preferably for ink of different colors, which can, for example, be located in a basic module so that all ink-jet printers can be provided with ink from a single or more central reservoirs, which is advantageous regarding maintenance and use of the inventive photo finishing system. The ink supply line in each module can be constructed to contact the ink supply line of adjacent modules to obtain ink from a first, for example, lower module, which can on the one hand be provided to the ink-jet printer of the respective module and can on the other hand be transported to an adjacent module to feed other ink-jet printers.

In a preferred embodiment a tension cylinder is provided, which can be rotatably driven, which tension cylinder comprises means for attaching or fixing sheet material, on which images should be printed by the at least one ink-jet printer of the invention, on the curved surface of the tension cylinder. The ink-jet printer can be in a fixed positional relationship to the tension cylinder. Holding means for a role of sheet material can be provided inside or outside the tension cylinder, which sheet material can be transported through a slit in the curved surface of the tension cylinder from the inside to the outside or by another conveying means onto the outside so that the automatic supply of sheet material for printing and waste of sheet material due to cutting or clipping this sheet material into different formats can be reduced. For the teaching regarding the tension cylinder and preferred embodiments thereof, reference is made to EP 1 009 158 A1 of the applicant, which is included herein by reference.

The above-mentioned tension cylinder can also be used for a multiplicity of ink-jet printers, which are, for example, stacked using the above described module technique. Thus, each single ink-jet printer or a defined group of inkjet printers can be supplied with sheet material using one or more tension cylinders. The operation of each tension cylinder can then be controlled via a bus system, which can also transmit picture data or control signals for the printers or associated switching elements.

In a preferred embodiment an interface is provided at the inventive photo finishing system to connect this system with an external device or a data net as, for example, the Internet. Thus, picture data or instructions of a customer regarding specific features of hard copies of pictures can be sent via the data net from a terminal, such as the personal computer of a customer, to the inventive photo finishing system. Features of the photoprint to be selected by the customer can be, for example, a specific format of the hard copy, the selection of a specific sheet material or the selection of a desired resolution or quality of the picture to be printed. Based on these customer instructions, the inventive photo finishing system can be controlled to print the desired hard copies.

Additionally, it is possible that an exposed photographic film of a customer can be developed and scanned to generate digital image data, which is sent to the customer via the data net using the interface. The customer can then decide which pictures should be printed. Additionally, the above-mentioned selection regarding features of the pictures to be printed, can be made by the customer and can be sent back to the photo finishing system of the invention.

The interface provided at the inventive photo finishing system can additionally be used for all purposes of e-commerce, like electronic payment for the development of the film and/or the printing of hard copies.

According to a general aspect of the present invention, the printer for printing images on the basis of image data obtained from an exposed photographic film is an ink-jet printer which can comprise additional features as described above or below.

Another aspect of the present invention is directed to a method for obtaining a printed image, wherein in a first step image data is obtained from an image data source. This can e.g. be the processing of an exposed photographic film to obtain a printed image comprising the steps of developing the exposed photographic film, and scanning the developed film to generate image signals representing an image of the photographic film. It is also possible to use a data source providing directly digital image data, as described above. The printing of the image is based on the generated image signal using at least one ink-jet printer.

### BRIEF DESCRIPTION OF THE DRAWINGS

The advantages of the present invention will become more apparent upon reading the detailed description of preferred embodiments in connection with the accompanying drawings, wherein:

FIG. 1 is a schematic diagram showing a preferred embodiment of a photo finishing system according to the present invention;

FIG. 2 is a schematic diagram showing an arrangement of a multiplicity of modules each comprising an ink-jet printer stacked on each other for printing images;

FIG. 3 is a perspective view of a tension cylinder;

FIG. 4 is a block diagram of an embodiment of the present invention.

FIG. 5 is a block diagram of a further embodiment of the present invention

FIG. 6 is a schematic diagram showing a photo finishing system of the prior art; and

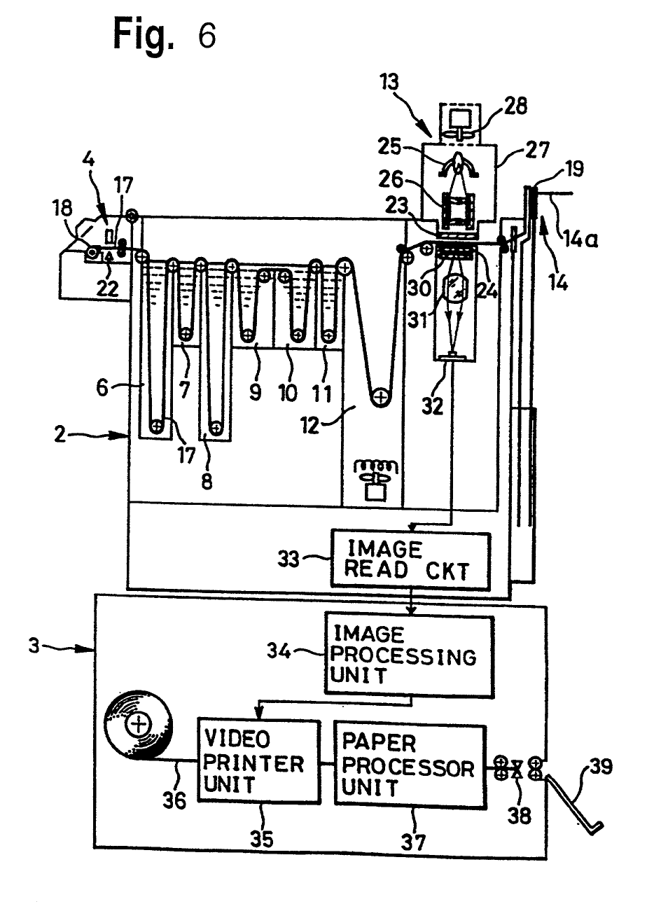

FIG. 7 is a schematic diagram showing a printer processor of the prior art.

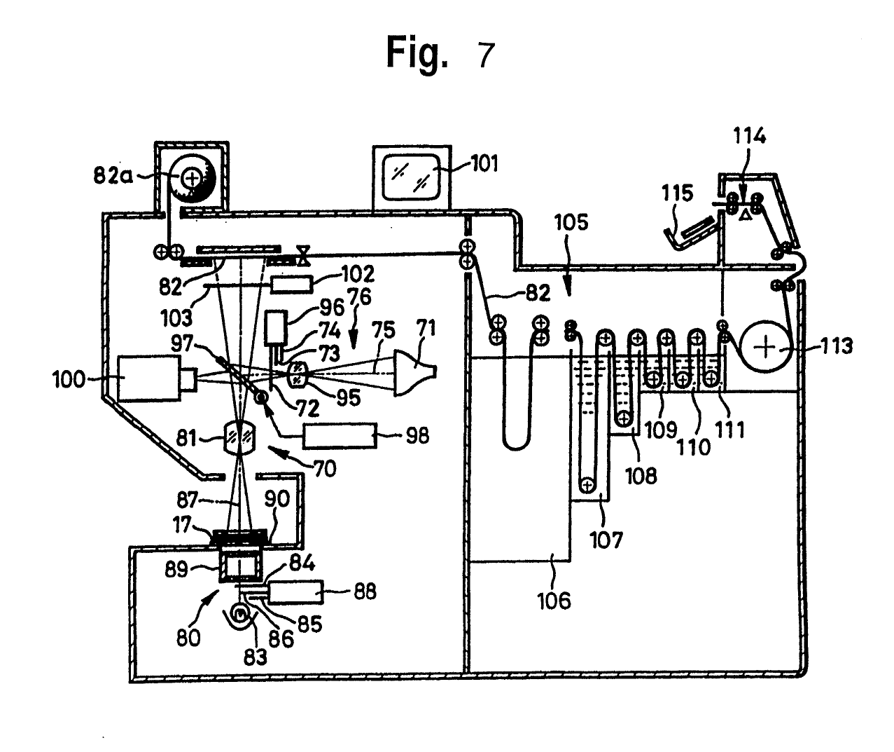

### DETAILED DESCRIPTION OF THE INVENTION

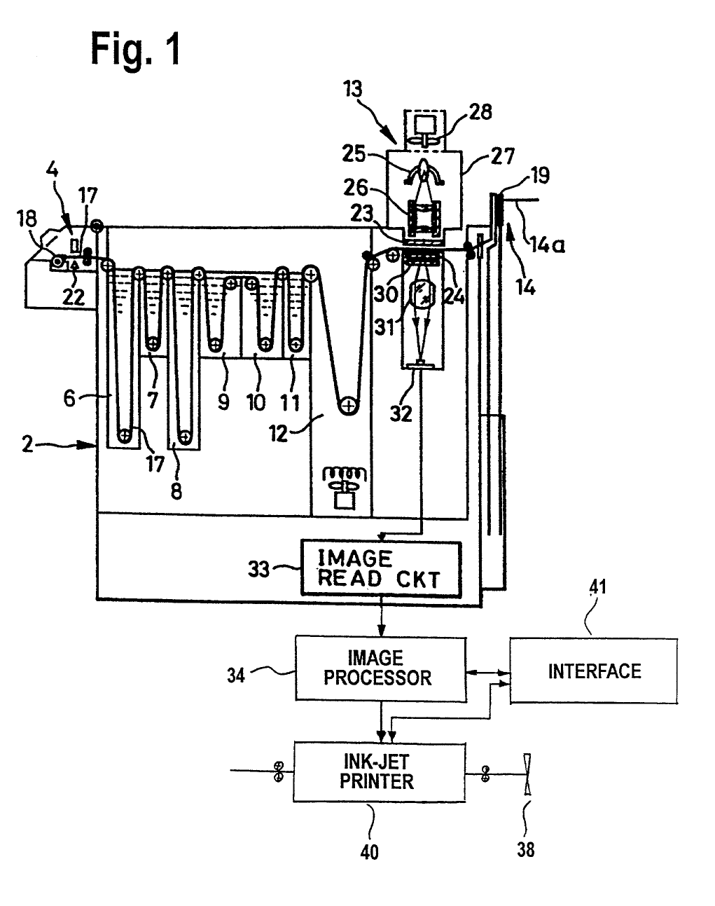

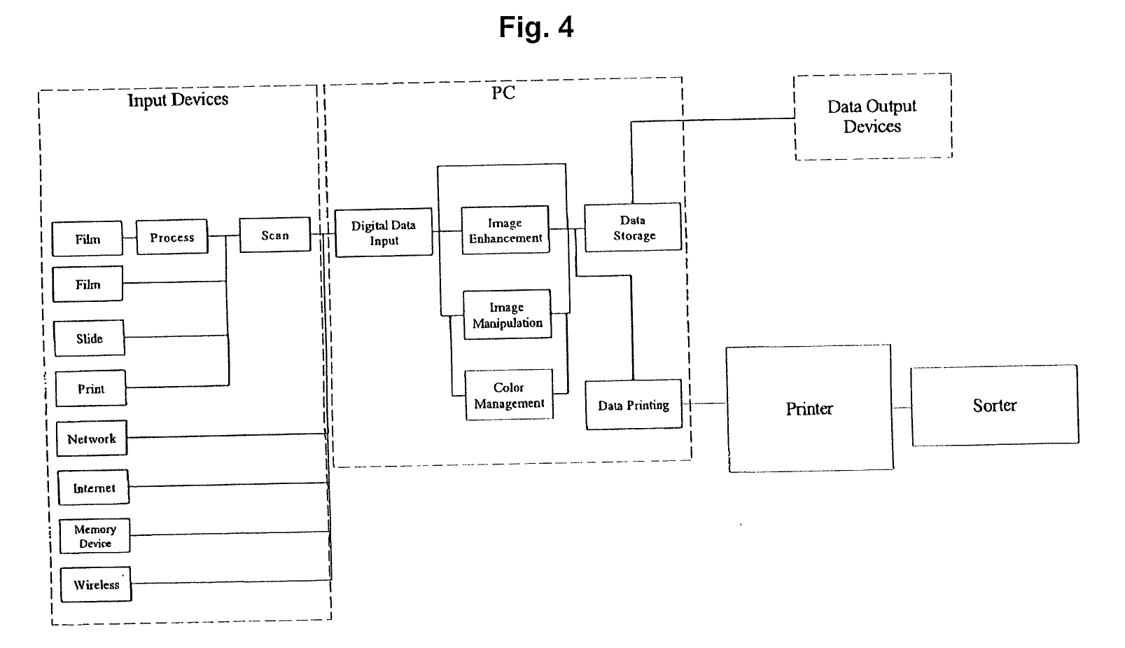

FIG. 1 shows a schematic diagram of a preferred embodiment of a photo finishing system according to the present invention. As far as the photo finishing system can be constructed as known in the prior art, the same reference numerals are used for designating the same devices as shown and described in FIG. 4.

The image read circuit 33 outputs data based on image data read from the processed film to the image processor 34, which can process the image signals to correct color and density or other features of the image. The image data processed by the image processor 34 is sent to the ink-jet printer 40 for generating a hard copy, such as a photoprint, of the image data. The sheet material output by the ink-jet printer 34 can be cut by a cutter 38 and can be ejected out onto a tray (not shown). If sheet material already cut into a specific size is used, the cutter 38 can be omitted. An interface 41 is in bidirectional communication with the image processor 34 and the ink-jet printer 40. Digital image signals output by the image processor 34 can be transferred via the interface 41 to a data network, such as the Internet, to send such image data to a customer. The customer can either further process the image data and send the further processed image data back via the interface 41 either to the image processor 34, or directly to the ink-jet printer 40, for obtaining a desired hard copy. Alternatively, the customer can simply send printing instructions to the inventive photo finishing system, which are translated into control signals for the ink-jet printer 40 and/or cutter 38.

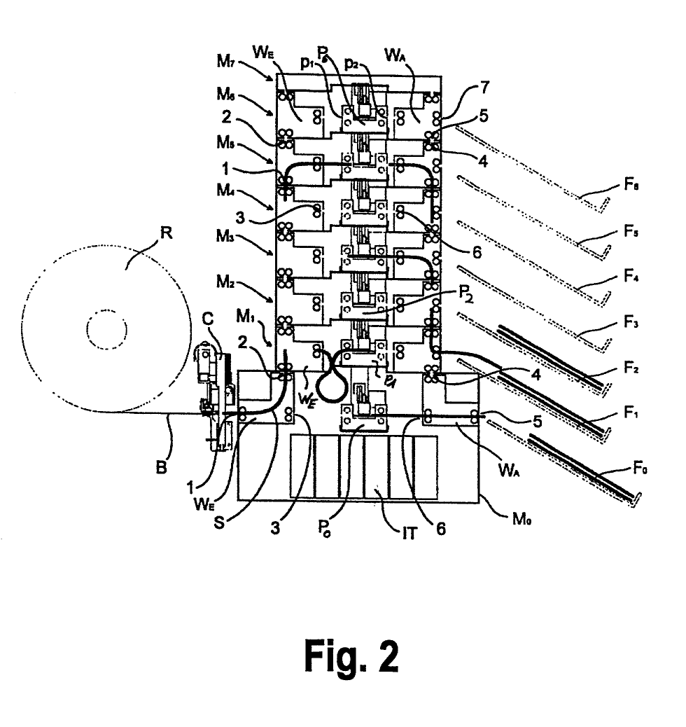

FIG. 2 shows a stack of modules M1 to M6, each comprising ink-jet printers P1 to P6 to be used in the present invention. A basic module M0 is arranged below the module M1 and a top module M7 is disposed on the uppermost module M6 and serves as a cover element for the modules. For the arrangement, construction and function of these printer modules including their devices, reference is made to European patent application no. 00 105 345.3, “Vorrichtung zum Bedrucken von Blattmaterial”, of the applicant, which is included herein by reference. In general, the shown modules represent only an embodiment of the present invention, so that e.g. a different number of printers can be employed.

Sheet material is provided on a roll R and cut by a cutter C into single sheets S. These sheets S are supplied to the basic module M0 and either printed by the ink-jet printer P0 or transferred to the adjacent module M1 depending on the setting of the first switching element WE. If the sheet material S is transferred to the adjacent module M1, it is output at the external output of the switching element WE and input to the switching element WE of the module M1. As in the switching element WE of the basic module M0, the sheet material S can either be directed to the printer P1 of the module M1 or can be directed to the switching element of the adjacent module M2 and so on. After the sheet material S is transferred to the desired printer in the desired module and printed, it is output to the output switching element WA of the respective module. Depending on the setting of the output switching element WA the sheet material S and can be transferred to a tray F at the module or can be transferred to an adjacent module above or below the current module to output the print in an order determined by the different customers.

Each input switching element WE has an external input 1, which can be arranged to receive sheet material S in a horizontal, vertical or tilted manner. An external output 2 is provided to output the input sheet material S in a desired direction, for example, to an adjacent module. An internal output 3 is provided to output the input sheet material S to the printer P of the respective module.

The output switching element WA has an internal input 6 for obtaining printed sheet material S from the printer P, an external input 4 for inputting the sheet material from outside, for example, from an adjacent module M, a first external output 5 for outputting the sheet, for example, to an adjacent module and a second external output 7 for outputting the sheet, for example, to a tray F.

The basic module M0 has a reservoir IT for ink of different color, which can be fed via lines provided in the respective modules to the ink-jet printers P of different modules.

In general, it is advantageous to construct the modules, especially the input and output switching elements WE and WA so, that several modules can be stacked while the input and output of the switching elements WE and WA are registered, namely in a horizontal and vertical arrangement allowing the forwarding of sheets S.

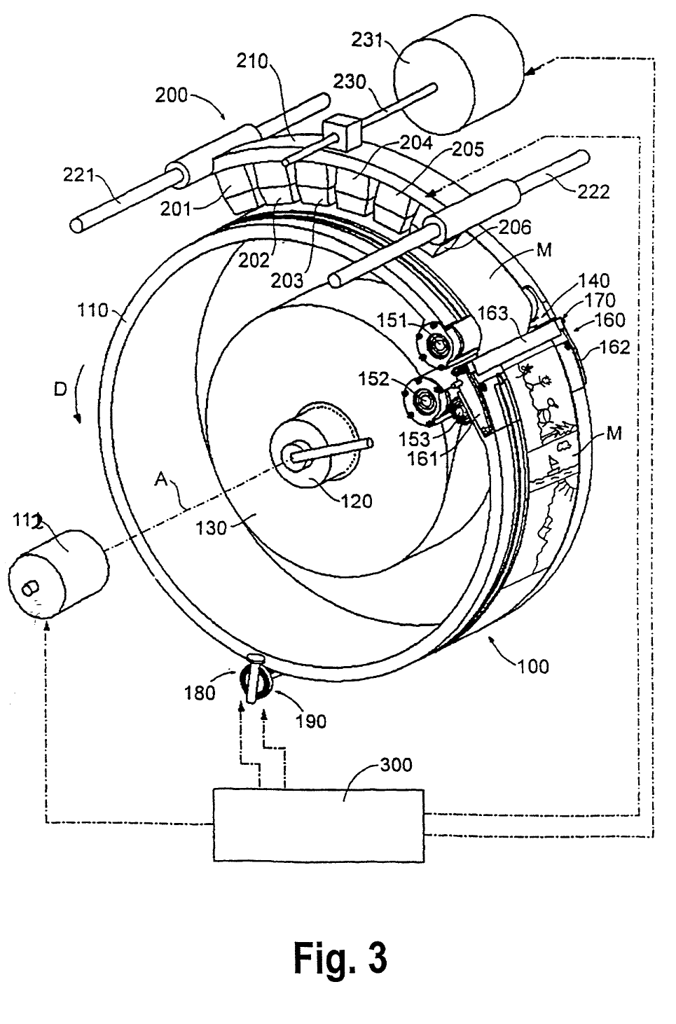

FIG. 3 shows a tension cylinder 100 having a holding means 120 inside for holding sheet material M in a roll 130. A slit 140 is provided in the surface 110 of the tension cylinder to allow the sheet material M to pass from the inside of the tension cylinder 100 to the outside surface 110 thereof. A holding means 160 is disposed near the slit 140 for holding the sheet material M. After outputting the sheet material M through the slit 140 using the rolls 152 and 153, the sheet material M is guided on the surface of the tension cylinder 100 and fixed via the holding means, e.g. a clamp 160. A motor 190 is not active while transferring the sheet material M onto the outside of the tension cylinder 100. After the sheet material M is fixed by the clamp 160, the cylinder 100 is rotated in direction of the arrow D by the motor 190.

An ink-jet printer 200 having several print heads 201 to 206 can print a picture onto the sheet material M. After the printing process is finished, the cylinder 100 is rotated again and the clamp 160 is moved to an open position so that the sheet material M is only held by a roll disposed outside the cylinder 100, or the motor 190, which can be in a position different from that shown in FIG. 3. A cutter 170 is provided to cut the end of the printed portion of the sheet material M so that different formats of photoprints can be generated without wasting sheet material.

FIG. 4 shows an embodiment of the present invention in a block diagram. In general any of the shown input devices can be used as the only image data source for providing image data. However, any combination of two our more of the shown input devices is possible. As data source for providing image data, an exposed film can be taken, which is processed and scanned. If a film already being processed is used as data source, the processing step can be omitted and the processed film can directly be scanned. Additionally, slides, prints or other graphical representations of images to be printed can be used by the present invention for generating image data by scanning the respective representation of the image to be printed or otherwise processed. Further devices for providing image data can be memory devices, like memory sticks, CDs, DVDs, magnetical discs or other known memory devices capable to store data. These memory devices can for example directly be read using for example a disc drive. Additionally, it is possible that image data be transmitted using a network, which can be any data connection from an image data source to the input device according to the present invention. Thus, for example a modem can be used to transmit image data via a telephone. Other networks, like the internet can be used to receive image data to be printed, so that an user can for example send an e-mail with image data attached to the inventive photo finishing system. It is also possible to use wireless data transmission to obtain image data from an user like for example a picture taken with a camera and transmitted via a mobile phone.

The image data obtained in the above mentioned manner is provided to an image processing device, which is in the shown embodiment of FIG. 4 a commercial available PC. Digital data is received at a digital data input, like an interface, and optionally can be subjected to one or more processing steps, like image enhancement, wherein for example a clear image is generated from a blurred image or an aberration resulting for example from a systematic error in an imaging device like the lens system of a camera can be corrected. Other image processing steps can be the manipulation of an image, like for example the brightening of an image, or adding of artificial features, like for example artificial fog or snow if requested by a user. Furthermore, a colour management of an image can be performed, wherein the hue of colours can be adjusted or corrected, or gamma correction can be performed. The unprocessed image or image data processed by one or more of the above mentioned steps is then transmitted to a data storage means and/or a data printing means. Data output devices can be provided, like for example an interface to transmit processed image data via a network, like the internet. It is also possible to provide other output means, like a disk drive or other means for writing data.

Data transmitted to the data printing device can be output to one or more printers to obtain hardcopies of the image data, which then can be sorted by a sorter depending on user demands.

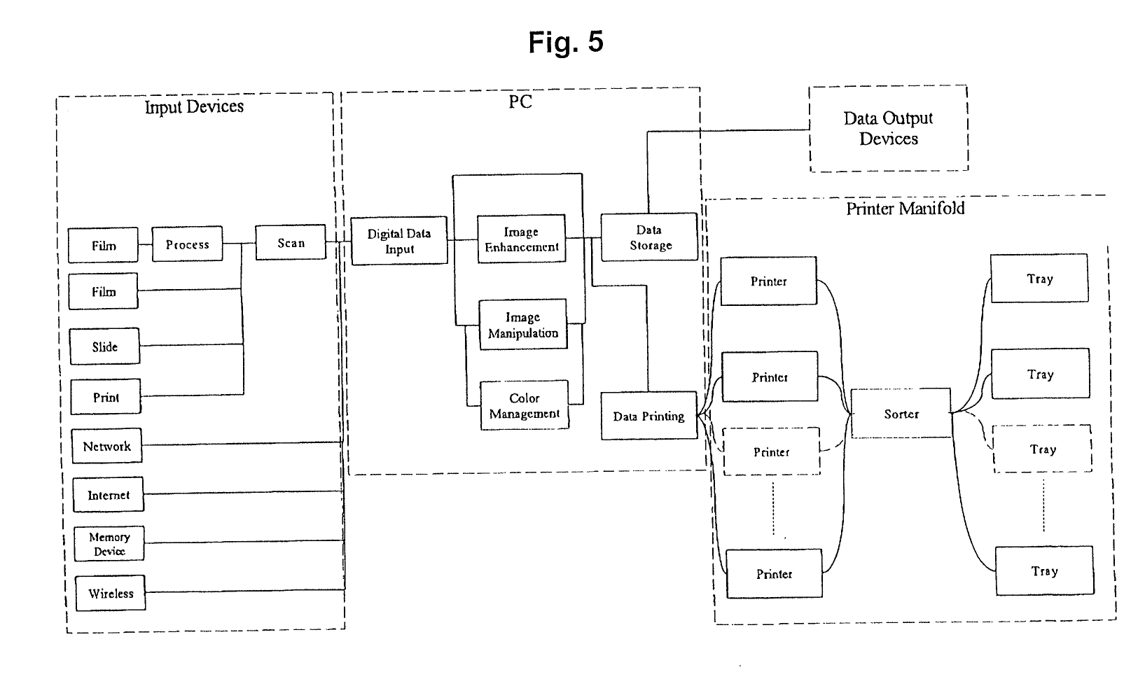

FIG. 5 shows a further embodiment of the invention having a printer manifold instead of the general printer device shown in FIG. 4. Data output from the data printing device is transmitted to a plurality of printers which can print images having different features regarding format, quality and so on, depending on instructions of a user, which instructions can have the form of picture associated data transmitted separately or together with the picture image data. A first printer of the printer manifold can for example print greeting cards, and a separate feeder for feeding unprinted greeting cards having a specified quality can be associated to this printer. A second printer can for example print pictures having a first format and is provided with sheet material from a role. A third printer can for example print images having a second format and is provided with sheet material being previously cut to print for example panorama prints. Further printers can be provided to print pictures based on the instructions of user. The printed pictures output of the respective printers can be conveyed to a sorter, which sorts the printed pictures in a desired order, so that for example the pictures of a first customer are output on a first tray, the picture of a second customer are output on a second tray, and so on. Any other arrangement of pictures is possible, so that the sorter can for example output a first set of picture printers for a specific customer onto a first tray, a first copy of the printed pictures onto a second tray, and so on. In general the sorter acts to convey printed images provided by one or more printers on to one or more trays according to customer instructions, wherein also specific images can be stored within the sorter, if for example not all print jobs for a customer are completed and it is desired that only a full set of printed images for a customer is output onto a specific tray.

1. A photo finishing system for printing images on a sheet material comprising:
an image data source for providing image data; and
at least one inkjet printer for printing an image on the sheet material in accordance with the image data.

2. A photo finishing system according to claim 1, wherein the image data source comprising:
a film processor having a developing unit and a drying unit to execute a developing process and a drying process of an unexposed photographic film;
an image scanner disposed downstream from the film processor, generating an image signal having data, which represents an image of the photographic film.

3. A photo finishing system according to claim 1, wherein the image data source is a digital image source directly providing digital image data.

4. A photo finishing system according to claim 1, wherein a multiplicity of ink-jet printers is provided.

5. A photo finishing system according to claim 1, wherein at least two ink-jet printers of a different type are provided.

6. A photo finishing system according to claim 1, wherein a multiplicity of ink-jet printers is arranged in modules.

7. A photo finishing system according to claim 1, wherein each pr inter has at least one input switching mean s.

8. A photo finishing system according to claim 1, wherein each printer has at least one output switching means.

9. A photo finishing system according to claim 1, comprising at least two sheet feeding devices for at least two different inkjet printers to provide sheets of different quality and/or format.

10. A photo finishing system according to claim 1, comprising a tension cylinder for providing sheet material to an ink-jet printer from a roll of sheet material inside or outside the cylinder to the outside of the cylinder, and a cutter to cut the sheet material into pieces of an arbitrary size.

11. A photo finishing system according to claim 1, comprising an interface for connecting the photo finishing system to an external device or a data net.

12. A printer for printing images on the basis of picture information of an exposed photographic film, wherein said printer is an ink-jet printer.

13. A method for obtaining a printed image comprising the steps:
obtaining image data from an image data source; and
printing the image with an ink-jet printer on the basis of the image data.

14. A method according to claim 13, wherein the image data is obtained by:
developing an exposed photographic film;
scanning the developed film to generate image signals having image data representing an image of the photographic film.

15. A method according to claim 13, wherein the image data source is a digital image data source.

16. A method according to claim 13, wherein the image data source is a digital memory device or a digital data network
